(19) United States
(12) Patent Application Publication
(10) Pub. No.: US 2011/0183728 A1
(43) Pub. Date: Jul. 28, 2011

(54) Mobile Phone Holder

(75) Inventor: Chu-Geng Lin, Taipei (TW)

(73) Assignee: CHENG UEI PRECISION INDUSTRY CO., LTD., Taipei (TW)

(21) Appl. No.: 12/691,933

(22) Filed: Jan. 22, 2010

(51) Int. Cl. H04M 1/00

(52) U.S. Cl. 455/575.1

(57) ABSTRACT

A mobile phone holder includes a frame, a holding means, a hinge means coupled the holding means with the frame and a locking means locked the holding means and the frame. The frame includes a base plate and a restricting means extended from three sides of a front of the base plate. A mobile phone is received in the frame from the remainder side thereof. The holding means is positioned at the remainder side of the frame for restricting the mobile phone according to the holding means rotated relative to the frame along a longitudinal direction of the frame and to the second side of the frame by the hinge means, and the holding means slid inwardly relative to the frame by the hinge means along a transverse direction of the base plate of the frame for being locked to the frame by the locking means.

### BACKGROUND OF THE INVENTION

1. Field of the Invention

The present invention relates to a mobile phone holder, more specifically, to a mobile phone holder with a latch.

2. The Related Art

Mobile phones have been developed in twenty years. As the living improved, the mobile phones have become an essential communication means. Nowadays, the mobile phones are multifunction, cheap and popular, and used every day and every where. The mobile phones can be carried in a pocket or a bag according to its compact size.

However, the mobile phones may fall in the ground from the pocket and broken in movement. Sometimes it is not easy to take the mobile phones out the bag. Hence, a mobile phone holder is developed for holding the mobile phones and hooking the mobile phones on a belt.

Please refer to FIG. 5. A conventional mobile phone holder 900 includes a base plate 902, a pair of holding arms 904 and a bottom plate 906. The holding arms 904 are extended from opposite sides of the base plate 902 and curved inwardly for chipping a mobile phone (not shown in figures). The bottom plate 906 is extended from a bottom side of the base plate 902 for supporting the mobile phone.

A receiving space 908 is formed among the base plate 902, the holding arms 904 and the bottom plate 908 for receiving the mobile phone. The mobile phone is received in the receiving space 908 from the top of the mobile phone holder 900. The holding arms 904 clip the mobile phone to retain the mobile phone in the receiving space 908. The base plate 902 further has a hooking means (not shown in figures) for hooking the mobile phone holder 900 with the mobile phone on the belt.

The mobile phone is apart from the mobile phone holder 900 by pulling the holding arms 904 outwardly and taking the mobile phone out of the receiving space 908. However, the mobile phone may fall in the ground owing to the top of the mobile phone holder 900 being exposed. On the other hand, the elasticity of the holding arms 904 may become fatigued if the holding arms 904 are long-term pulled.

### SUMMARY OF THE INVENTION

An object of the present invention is to provide a mobile phone holder with a latch.

According to the invention, the mobile phone holder includes a frame, a holding means, a hinge means and a locking means. The frame includes a base plate defining a front surface, a first side, a second side opposite to the first side and opposite ends, and a restricting means extended from the first side and the opposite ends of the front surface of the base plate.

The base plate and the restricting means together surround a receiving space therebetween for receiving the mobile phone from the second side of the base plate of the frame. The holding means is positioned at the second side of the base plate of the frame. The hinge means couples the holding means with the frame. The locking means locks the holding means and the frame.

If the mobile phone holder is in a restricting status, the frame and the holding means are together retained the mobile phone. If the mobile phone holder is in a free status, first, the holding means will slide outwardly relative to the frame by the hinge means along a transverse direction of the base plate of the frame for releasing the locking means to unlock the holding means and the frame. Second, the holding means will rotate relative to the frame along a longitudinal direction of the base plate of the frame and away from the second side of the base plate of the frame by the hinge means.

Hence, the mobile phone can be pushed in or pulled out of the receiving space of the frame from the second side of the base plate of the frame. The holding means can be latched to the frame for restricting the mobile phone in the receiving space of the frame, and unlocked from the frame for releasing the mobile phone.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a mobile phone holder seen from the rear according to the present invention;

FIG. 2 is a perspective view of the mobile phone holder seen from the front according to the present invention

FIG. 3 is an exploded view of the mobile phone holder seen from the rear according to the present invention;

FIG. 4 is an exploded view of the mobile phone holder seen from the front according to the present invention; and

FIG. 5 is a perspective view showing a conventional mobile phone holder.

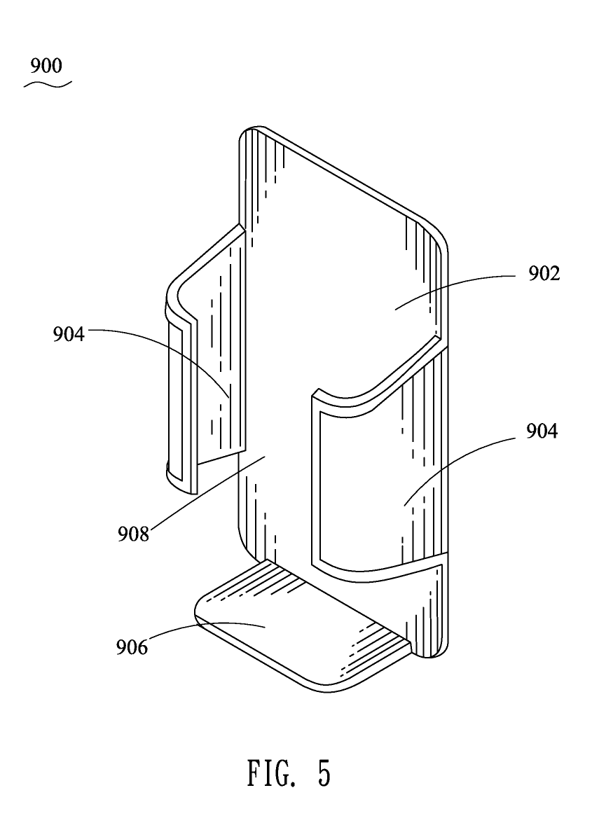

### DETAILED DESCRIPTION OF THE PREFERRED EMBODIMENT

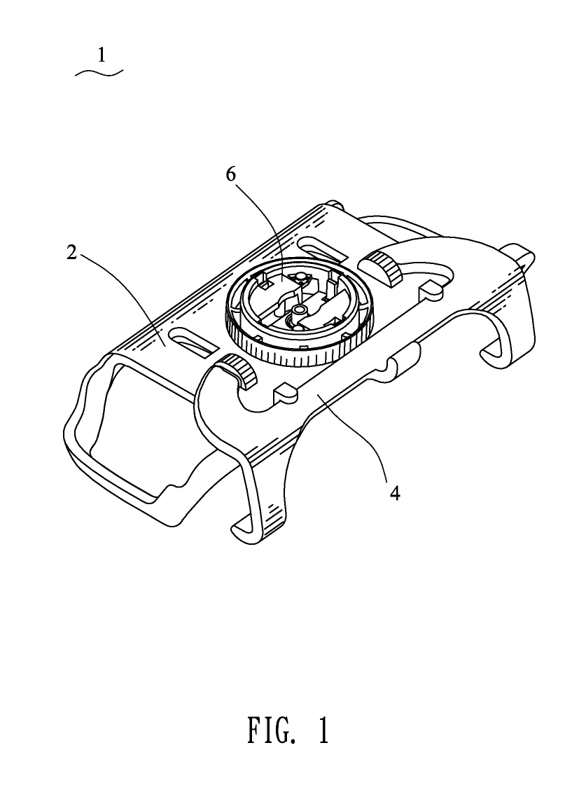

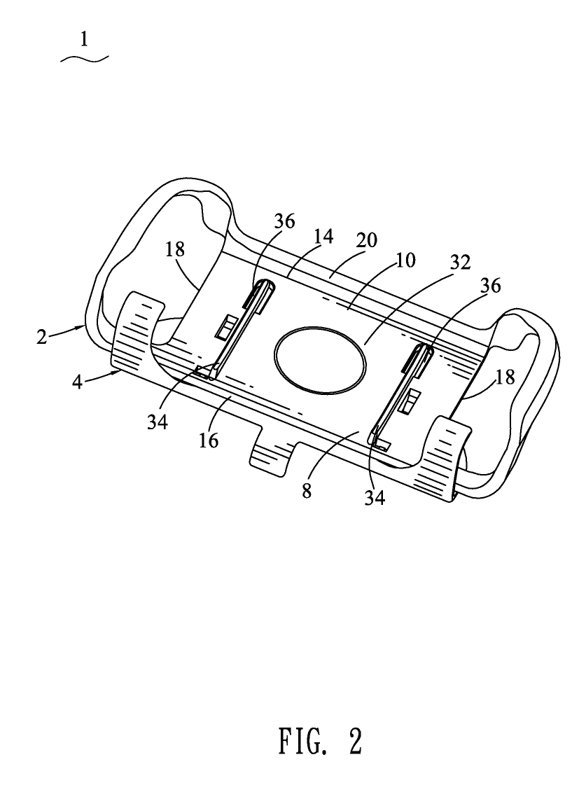

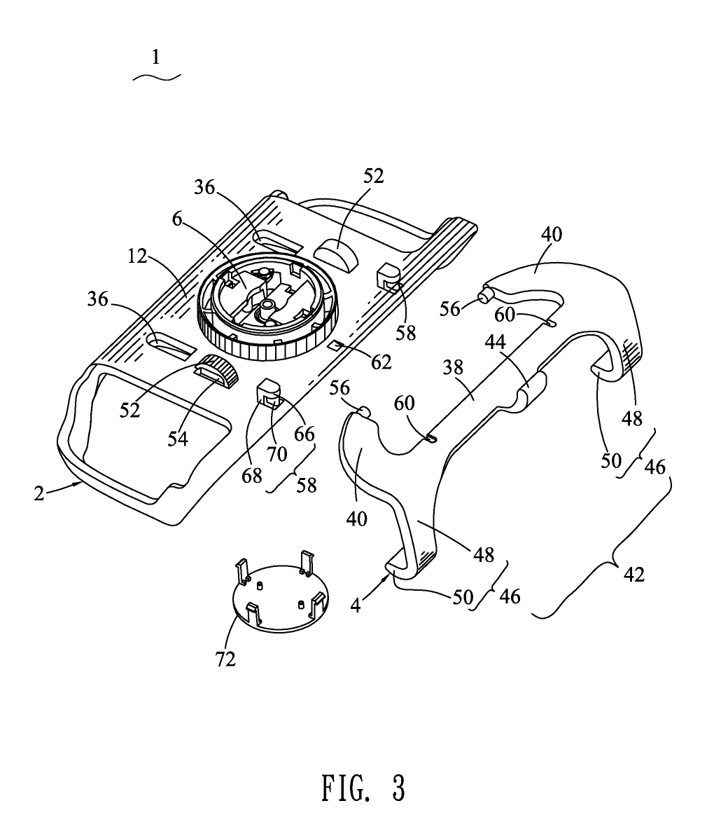

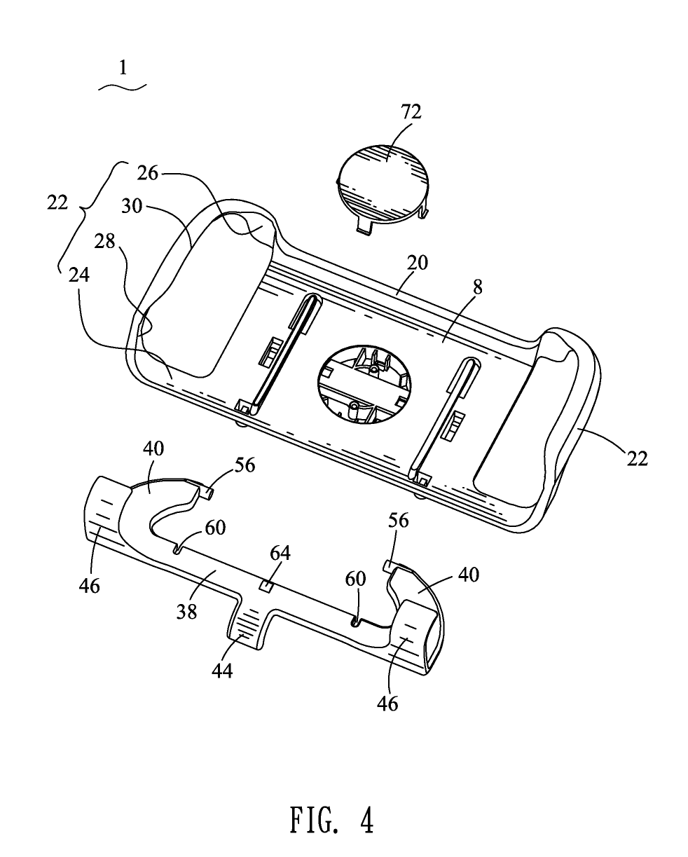

Please refer to FIG. 1 to FIG. 4. The mobile phone holder 1 includes a frame 2, a holding means 4, an attaching means 6, a hinge means and a locking means. The frame 2 includes a base plate 8 and a restricting means. The base plate 8 is of a rectangular shape and defines a front surface 10, a rear surface 12, a first side 14, a second side 16 opposite to the first side 14 and opposite ends 18.

The restricting means includes a first restricting plate 20 and a pair of restricting portion 22. The first restricting plate 20 is vertically extended from the first side 14 of the first surface 10 of the base plate 8. Especially, the first restricting plate 20 is of a long narrow strip of which the length is same with the base plate 8.

The restricting portions 22 are extended from the opposite ends 18 of the base plate 8 respectively. Each of the restricting portions 22 includes a connecting plate 24, a second restricting plate 26 and a third restricting plate 28. The connecting plate 24 is extended outwardly from the opposite ends 18 along a longitudinal direction of the base plate 8. Especially, the connecting plate 24 and the base plate 8 are at the same plane.

The second restricting plate 26 is extended outwardly from opposite ends of the first restricting plate 20 along the longitudinal direction of the base plate 8. The third restricting plate 28 is vertically extended from the free end of the connecting plate 24 and to the second restricting plate 26. A top edge of the third restricting plate 28 is curved inwardly to form a restricting rim 30. Especially, each of the connecting plate 24, the second restricting plate 26 and the third restricting plate 28 is of a long narrow strip.

A receiving space 32 is formed between the base plate 8 and the restricting means for receiving a mobile phone (not shown in figures). The front surface 10 of the base plate 8 is extended to form a pair of elastic strips 34 adjacent to and parallel with the opposite ends 18 thereof. The base plate 8 is formed a pair of slots 36 penetrating the front surface 10 and the second surface 12 thereof. Each of the slots 36 is aligned with one end portion of each of the elastic strips 34.

The holding means 4 includes a main portion 38, a connecting portion 40, a holding portion 42 and an operating portion 44. The main portion 38 is of an elongated plate defining a first side, a second side opposite to the first side and opposite ends. The connecting portion 40 includes a pair of connecting arms extended from opposite ends of the first side of the main portion 38.

The holding portion 42 includes a pair of restricting arms 46 extended from the opposite ends of the second side of the main portion 38. Each of the restricting arms 46 includes a restricting board 48 vertically extended from each of opposite ends of the second side of the connecting portion 38 and a restricting piece 50 vertically extended from the free end of the restricting board 50 and towards the second side of the main portion 38. The connecting portion 40 and the restricting piece 50 are parallel to each other.

The operating portion 44 is extended from a middle portion of the second side of the main portion 38. The operating portion 44 is of a curved-shaped. Especially, the free end of the operating portion 44 and the restricting board 48 are extended towards opposite directions.

The attaching means 6 is formed at a middle portion of the rear surface 12 of the base plate 8 and capable of engaging with a suction cup or a hooking means for being mounted to a plane or a belt (not shown in figures).

The hinge means includes a pair of hinge blocks 52, a pair of hinge slots 54 and a pair of hinge pins 56. The hinge blocks 52 are projected from the rear surface 12 and located adjacent to the opposite ends 18 of the base plate 8 of the frame 2. Each of the hinge slots 54 is formed in the hinge block 52. Each of the hinge pins 56 is projected from the free end of the connecting portion 40 of the holding means 4 and coupled into the hinge slot 54. Especially, the hinge pins 56 are projected to each other.

The locking means includes a pair of locking bases 58, a pair of locking slots 60, a locking recess 62 and a locking bulge 64. The locking bases 58 are adjacent to the second side 16 of the base plate 8 and respectively aligned with the hinge blocks 52. Each of the locking blocks 58 includes a blocking piece 66, a connecting piece 68 and a locking piece 70.

The connecting piece 68 is vertically extended from the rear surface 12 of the base plate 8. The blocking piece 66 is extended from the free end of the connecting piece 68 and parallel with the base plate 8. The locking piece 70 is formed among the rear surface 12 of the base plate 8, the connecting piece 68 and the blocking piece 66. The locking slots 60 are formed at the first side of the main portion 38 and respectively aligned with the locking piece 70.

The locking recess 62 is formed on the rear surface 12 and adjacent to a middle portion of the second side 16 of the base plate 8. The locking bulge 64 is projected from the middle portion of the first side of the main portion 38 and aligned with the locking recess 62. The mobile phone holder 1 further includes a label plate 72 fixed to the front surface 10 of the base plate 8.

While the mobile phone holder 1 is assembled, the hinge pin 56 is slid into the hinge slot 54. While the mobile phone holder 1 is in a restricting status, the locking piece 70 is slid into the locking slot 60. The first side of the main portion 38 is fixed between the rear surface 12 of the base plate 8 and the blocking piece 66. The locking bulge 64 is engaged into the locking recess 62. Hence, the holding means 4 is engaged with the frame 2 by the locking means. The mobile phone is received in the receiving space 32.

The base plate 8 supports a rear surface of the mobile phone. The third restricting plates 28 of the restricting means abut against a top surface and a bottom surface of the mobile phone. The first restricting plate 20 and the second restricting plate 26 abut against a right surface of the mobile phone. The restricting boards 48 of the holding means 4 abut against a left surface of the mobile phone. The restricting rim 30 of the restricting means and the restricting pieces 50 of the holding means 4 abut against a front surface of the mobile phone.

Hence, the mobile phone is restricted in the receiving space 32 by the restricting means and the holding means 4. Furthermore, the elastic strips 34 abut against the rear surface of the mobile and urge the mobile phone to abut against the restricting rim 30 of the restricting means and the restricting pieces 50 of the holding means 4.

While the mobile phone holder 1 is in a free status, the mobile phone is released from the receiving space 32 of the mobile phone holder 1. First, the operating portion 44 of the holding means 4 is manually pulled outwardly along a transverse direction of the base plate 8 of the frame 2. Hence, the hinge pin 56 is slid in the hinge slot 54 and towards second side 16 of the base plate 8. The locking piece 70 is disengaged from the locking slot 60. The locking bulge 64 is disengaged from the locking recess 62. Hence, the fist side of the main portion 38 is separated from the locking base 58, and the restricting pieces 50 of the holding means 4 is pulled outwardly from the receiving space 32.

Second, the holding means 4 is pivot on the hinge means and is rotated relative to the frame 2 along the longitudinal direction of the base plate 8 of the frame 2. Hence, the main portion 38 of the holding means 4 is rotated from the second side 16 of the base plate 8 to the first side 14 of the base plate 8. The mobile phone can be manually pulled out of the receiving space 32 from the second side 16 of the base plate 8 of the frame 2.

If the mobile phone is pushed into the receiving space 32, first, the main portion 38 of the holding means 4 is pivot on the hinge means and is rotated relative to the frame 2. The hinge pin 56 is pivoted in the hinge slot 54. The main portion 38 and the restricting arms 40 of the holding means 4 are rotated to the second side 16 of the base plate 8 of the frame 2.

Second, the holding means 4 is pushed toward the first side 14 of the base plate 8 of the frame 2 along the transverse direction. The hinge pin 56 is slid along the hinge slot 54 and towards the first side 14 of the base plate 8. The locking piece 70 is engaged into the locking slot 60. The locking bulge 64 is engaged into the locking recess 62. The first side of the main portion 38 of the holding means 4 is engaged with the locking base 58. Hence, restricting arms 40 of the holding means 4 is positioned at the second side 16 of the base plate 8 of the frame 2.

As described above, the base plate 8 supports the rear surface of the mobile phone, the restricting means of the frame 2 abuts against the right surface, the top surface, the bottom surface and the front surface of the mobile phone for retaining the mobile phone in the receiving space 32 of the frame 2.

The holding means 4 is rotated relative to the frame 2 by the hinge means in the restricting status where the restricting arms 46 positioned at the second side 16 of the base plate 8 of the frame 2 for abutting against and restricting the left surface and the front surface of the mobile phone, and in the free status where the restricting arms 46 is away from the second side 16 of the base plate 8 of the frame 2. Hence, the mobile phone is pulled out of the receiving space 32 from the second side 16 of the base plate 8 of the frame 2.

Hence, the mobile phone can be pushed in and pulled out of the receiving space of the frame from the second side of the base plate of the frame. The holding means can be latched to the frame for restricting the mobile phone in the receiving space of the frame, and unlocked from the frame for releasing the mobile phone.

Furthermore, the present invention is not limited to the embodiments described above; diverse additions, alterations and the like may be made within the scope of the present invention by a person skilled in the art. For example, respective embodiments may be appropriately combined.

What is claimed is:

1. A mobile phone holder for retaining a mobile phone, comprising:
a frame comprising
a base plate defining a front surface, a first side, a second side opposite to the first side and opposite ends;
a restricting means extended from the first side and the opposite ends of the front surface of the base plate; and
a receiving space surrounded by the base plate and the restricting means for receiving the mobile phone from the second side of the base plate of the frame;
a holding means positioned at the second side of the base plate of the frame;
a hinge means coupling the holding means with the frame; and
a locking means locking the holding means and the frame; and
wherein the frame and the holding means are together retained the mobile phone in a restricting status, the holding means is slid outwardly relative to the frame by the hinge means along a transverse direction of the base plate of the frame for releasing the locking means to unlock the holding means and the frame, and then is rotated relative to the frame along a longitudinal direction of the base plate of the frame and away from the second side of the base plate of the frame by the hinge means in a free status.

2. The mobile phone holder as claimed in claim 1, wherein the hinge means comprises at least one a hinge slot formed along the transverse direction and at least one hinge pin pivot in the hinge slot and slid along the hinge slot.

3. The mobile phone holder as claimed in claim 2, wherein the hinge slot is formed at a rear surface of the base plate and the hinge pin is formed at the holding means.

4. The mobile phone holder as claimed in claim 3, wherein the rear surface of the base plate of the frame projects a pair of hinge blocks, the hinge slot is formed in each of the hinge blocks, the holding means comprises a main portion, a connecting portion extended from the main portion and a holding portion extended from the main portion, the hinge pin is extended from the connecting portion, the holding portion is positioned at the second side of the base plate of the frame in the restricting status.

5. The mobile phone holder as claimed in claim 4, wherein the main portion of the holding means defines a first side, a second side opposite to the first side and opposite ends, the connecting portion is extend from opposite ends of the first side of the main portion, the holding portion comprising a pair of restricting arms extended from opposite ends of the second side of the main portion respectively and positioned at the second side of the base plate of the frame.

6. The mobile phone holder as claimed in claim 5, wherein the main portion of the holding means is positioned at the second side of the rear surface of the base plate of the frame, the restricting arms are vertically extended from the main portion.

7. The mobile phone holder as claimed in claim 6, wherein the each of the restricting arms includes a restricting board vertically extended from each of opposite ends of the second side of the connecting portion and a restricting piece vertically extended from the free end of the restricting board and into the receiving space.

8. The mobile phone holder as claimed in claim 7, wherein the rear surface of the base plate of the frame is formed an attaching means.

9. The mobile phone holder as claimed in claim 7, wherein the front surface of the base plate of the frame is formed a pair of elastic strips.

10. The mobile phone holder as claimed in claim 9, wherein the front surface of the base plate of the frame is formed a pair of slots, each of the slots is aligned with an end of each of the elastic strips.

11. The mobile phone holder as claimed in claim 10, wherein the elastic strips are extended along the transverse direction.

12. The mobile phone holder as claimed in claim 7, further comprising a label plate fixed to the front surface of the base plate of the frame.

13. The mobile phone holder as claimed in claim 7, further comprising an operating means extended from a middle portion of the second side of the main portion.

14. The mobile phone holder as claimed in claim 13, wherein the operating portion is of a curved-shaped, the free end of the operating portion and the holding arms are extended towards opposite directions.

15. The mobile phone holder as claimed in claim 7, wherein the locking means comprise a pair of locking bases and a pair of locking slots engaged with the locking bases respectively.

16. The mobile phone holder as claimed in claim 15, wherein each of the locking bases comprise a connecting piece extended from the rear surface of the base plate of the frame, a blocking piece extended from the free end of the connecting piece and towards the second side of the base plate, and a locking piece extended among the rear surface of the base plate and the connecting piece and the blocking piece, the locking bases are formed at the first side of the main portion of the holding means.

17. The mobile phone holder as claimed in claim 16, wherein the first side of the main portion of the holding means is fixed among the rear surface of the base plate of the frame, the connecting piece and the blocking piece in the restricting status.

18. The mobile phone holder as claimed in claim 7, wherein the restricting means comprises a first restricting plate vertically extended from the first side of the first surface of the base plate, and a pair of restricting portion vertically extended from the opposite ends of the base plate respectively.

19. The mobile phone holder as claimed in claim 18, wherein each of the restricting portions includes a connecting plate extended outwardly from the end of the base plate along the longitudinal direction, a second restricting plate extended outwardly from opposite ends of the first restricting plate along the longitudinal direction, and a third restricting plate vertically extended from the free end of the connecting plate and to the second restricting plate.

20. The mobile phone holder as claimed in claim 19, wherein a top edge of the third restricting plate is curved inwardly to form a restricting rim.
